(19) United States
(12) Patent Application Publication
(10) Pub. No.: US 2009/0281953 A1
(43) Pub. Date: Nov. 12, 2009

(54) Seller's Listing System

(76) Inventor: James Ruskowski, Woodstock, CT (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/428,721

(22) Filed: Apr. 23, 2009

Related U.S. Application Data
(60) Provisional application No. 61/050,742, filed on May 6, 2008.

(51) Int. Cl. G06Q 30/00; G06Q 20/00; G06Q 40/00; G06Q 50/00

(52) U.S. Cl. 705/80; 705/26; 705/27; 705/10; 705/14.73; 705/4

(57) ABSTRACT

A method, apparatus and computer program product for providing a seller's listing system is presented. By way of the seller's listing system information services and sales tools are online at a property specific sales and information center. Sellers have full access to an organized system that gives them complete control all the way through the entire sales process. Up to the minute answers and exact information are reported directly to the seller. Every entity, professional and company involved in the transaction reports to the seller via the Internet.

### CROSS REFERENCE TO RELATED APPLICATIONS

The present application claims the benefit of U.S. Provisional Patent Application No. 61/050,742, filed on May 6, 2008, which is incorporated herein by reference in its entirety.

### BACKGROUND

The monologue Multiple Listing Service for listing real estate typically gives a seller just a single page of property information. This can result in a waste of time of the sellers, the realtors and potential buyers. Typically, a relatively small amount of information is presented, requiring interested potential buyers to waste time, as they must contact the seller or seller's agent to find out more information regarding the property of interest.

### SUMMARY

A completely new real estate sales system is now available over the Internet (e.g., at a website (www.sellerslistingsystem.com). The web site helps seller's market their properties faster, more efficiently and for less money than ever before.

The seller's listing system website replaces the expense and problems of listing brokers with Internet technology. Information services and sales tools are online at a property-specific sales and information center. For the first time seller's have full access to an organized system that gives the seller complete control all the way through the entire sales process. Up to the minute answers and exact information are reported directly to the seller. Every entity, professional and company involved in the real estate transaction will now report to the seller via the Internet. The exact status of the transaction is no longer a mystery.

It is to be understood that the embodiments of the invention can be embodied strictly as a software program, as software and hardware, or as hardware and/or circuitry alone.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B depict a flow diagram of a particular embodiment of a method for providing a seller's listing system in accordance with embodiments of the invention; and

FIG. 2 illustrates an example computer system architecture for a computer system that provides a seller's listing system in accordance with embodiments of the invention.

### DETAILED DESCRIPTION

The seller's listing system replaces the expense and problems of listing real estate brokers with Internet technology. Information services and sales tools are available online at a property specific sales and information center. For the first time sellers have full access to an organized system that gives the seller complete control all the way through the entire sales process. Up to the minute answers and exact information are reported directly to the seller. Every entity, professional and company involved in the transaction will now report to the seller via the Internet. The exact status of the transaction is readily available.

In a particular embodiment, there are three distinct types of users of the system, each having a differing set of needs and use for the information. The three different categories of users each having different access and views of various content of the website.

The three different categories of users are Sellers, Buyers (including Buyer's Agents) and Negotiators (Sellers and Buyers). Each of these different users has completely different access to the seller's listing system website and its information. A separate level for each user type has been established.

Sellers have unrestricted access to site, utilizing their own specific code to gain full access. At the seller's discretion, this code can be shared with others, for example, co-owners, partners, children, advisors or attorneys. Privileged access and information is available only to the seller.

The seller's pages include a pre-marketing area and a marketing/sales area. The pre-marketing area contains a referral lists of inspectors, with completed inspections emailed back to the seller. The inspections are stored and printable when needed. The seller's pages also includes competition tracking and mapping including a listing of what's available for comparable properties in the seller's area, and what's sold for comparable properties in the seller's area. Also included are statistics such as the average days on market in seller's area, the average price per square foot, and a referral list of local attorneys.

The marketing/sales area includes full property information listed on sellers unique pages, such as property description, property features, pricing, commission offering to buyers bents, pictures, directions and mapping. The marketing/sales area may also include an optional, walk on celebrity showing of rooms or features, showing instructions, other potential higher and better uses and customized helpful links hand chosen by seller such as area school rankings, area recreation, area medical facilities, demographics, special sites and helpful blogs.

The marketing/sales area may further include on line advertising information sharing permitting easy downloading of the seller's property information page onto the websites of newspapers, a list of newspaper sites and contact information, tracking of hits received, summary of other websites advertised on, dates run, renewal dates, amount spent, and type of ads—open house, for sale, for lease and the like.

In certain embodiments the marketing/sales area may further include instant email notification of buyer interest, optional phone notification of buyer interest, history of direct buyer showings, history of buyer agent showings, and a summary of line (print) advertising including dates run, renewal dates, the type of ad—open house, fore sale, for lease, etc., the amounts spent and the source of response tracking.

Additionally, the marketing/sales area may further include optional line ad placement services, signage (including For sale, For lease, Rental, Open house, and the like). Lock boxes that are optional, available as rental—return after use, standard boxes, electronic boxes and downloadable information for instant tracking and accessible only by registered Buyers agents

Also included in the marketing/sales area is an ongoing online resources area, which includes: buyer acknowledgement of no agent representation (seller can sell directly to buyer), commission offering and acceptance from buyer's agents, buyers agent registration and Radio Frequency Identification (RFID), buyers agent proof of insurance, buyer feedback about property which provides useable constructive criticism. Also included are ratings of area professionals from previous Sellers experience. This can include opinions concerning abilities, fees and ethics of insurance companies, agents, attorneys, inspection companies, escrow companies and consultants.

Further still, the marketing/sales area may include proof of error and omissions insurance and certificates of insurance from buyer's agent, inspection companies, attorneys, appraisers, consultants and engineers.

Also included is a free ebook, titled “The Real Estate Revolution”, which includes 12 principals for success, useful explanations, examples and frequently asked questions (FAQs). There may additionally be local area on line discussion groups for discussing what's selling, what's working, and who's buying. A Match Maker/Match Maker area includes a listing of buyer's postings of property wanted/needed. There may further be a Fire Sale listings of sellers desperate to sell.

The seller's pages also include the deal status such as negotiating/under agreement that includes an offers section wherein all offers are done online so there are no face-to-face or live negotiations, counter offers, rejections, and acceptance. For accepted offers there will be deposits (utilizing Paypal or other for immediate binding of agreement), held by seller or sellers attorney and escrow.

A Purchase and Sale (P and S) Agreement can be reviewed, the P and S prepared by seller's attorney and delivered to all via email. Also included are contingencies such as financing including buyer permission for financial institution to disclose any and all information to seller or seller's representative. Also included are banking information including name, address, loan officer or originator and contact information including email, phone numbers and superiors contact information. Also included is a bank agreement to cooperate and disclose to seller on a daily basis via email the exact status of buyers loan including date applied, pre-qualified, anticipated commitment date, needed/missing information, key date—milestones—sink/swim, commitment with conditions, commitment, denial and appraisal. Additionally included is closing information such as needed documents, smoke alarm certificate, certificate of occupancy for new construction, email notification of closing schedule by bank to all parties involved, banks attorney, seller, sellers attorney, buyer, buyers attorney, buyers agent, insurance company, escrow company, location and bank attorney information. Also included may be any additional inspection or testing performed by buyer at buyer's expense, wherein the results are shared with the seller via email and which becomes property of the seller if transaction is not consummated.

The seller's page may further include information relating to commercial or business transactions and include due diligence periods, milestone dates, municipal/governmental permits or approvals including dates applied, meeting schedules, approval/denials, and appeals periods. Any and all plans, permits or approvals become property of the seller if transaction is not consummated.

Also included are items related to the closing including utility disconnect and switch into buyers account, keys, witnessed/notarized signature of deed, copies of all closing documents via email as well as hard copies. The seller is able to download all information to closing documentation file for safe and future reference. The seller's area also permits the emailing of Real Estate Settlement Procedures Act (RESPA) to accountants for tax purposes.

Another section is the Buyer Pages. Here, the buyers and buyer's agents have access to pertinent property information. A user can pull up the Sellers Listing System.com and search away. No registration is required. This section can be used to find where the property is located, what the asking price is, description and features of the property, showing instructions, commission offering to buyers agent, contact information (sellers preference), pictures, highest and best use for potential changes such as sub-dividable, zoning changes, conversions, land use change, celebrity showings (utilizing walk on technology) and links to seller selected sites.

This area can also be used to schedule a showing (at sellers preference by phone or email). Agents need to be registered and provide proof of error and omissions insurance and agree to terms and conditions of commission offering.

Before an offer is submitted the following agreements and acknowledgements must be accepted as part of the standard Sellers Listing System.com format. These include waiver of agent representation (needed from buyer if no agent is used and avoids issues or surprises later on). An agreement of commission offering and terms if a buyer's agent is involved. An acknowledge receipt and review of all seller-performed inspections. An agreement that all negotiations shall take place through SLS.com and not in person or by phone with an agent. If the situation warrants, with the seller's permission live negotiations can take place through the seller's attorney. An agreement that any financing contingencies shall include a signed approval and permission given from the buyer to the buyer's lending institution that any and all information concerning the transaction and financing application shall be shared with the seller on a daily basis through the SLS.com system. An agreement from the buyer that any additional testing, inspections and appraisals from any source whatsoever shall be sent and shared with the seller. If the transaction is not consummated said information and reports shall become the property of the seller and can be used at the seller's discretion.

There are three types of offers forms available:

1) The automatic offer form is the standard with the majority of information filled in using the property listing information that has previously been provided.

2) A Boiler Plate Offer form that enable both parties more leeway for adding information.

3) Offers generated by others can be downloaded to the system for all to review, change, refuse or execute.

Automatic offer forms will fill in the majority of information. The following information will need to be filled in: buyer or buyers legal names, dollar amount of offer for the property, dollar amount of deposit with the offer (deposit money to be held by seller, seller's attorney or in escrow and may be payable through Paypal at sellers request). Also included is the dollar amount of additional deposit with purchase and sale agreement (to be held in same location as original deposit, and payable in form acceptable to seller).

Contingencies are also listed here. Contingencies may include financing, additional inspections and reports, approvals or permits, and dates certain amounts are requested. Contingencies may further include additional provisions, closing date, counter offer, rejected offer and accepted offer.

Boiler Plate forms are similar to the automatic offer forms only they do not contain specific information from the property listing sections. Therefore there is more blank area for accepting additional or custom information.

Offers generated by other are done so off site and downloaded for consideration of the parties involved. These are best suited for complicated deals such as commercial or land sales.

After all parties have accepted the Offer to Purchase, then a more lengthy and formal contract known as The Purchase and Sale Agreement needs to be generated by the seller's attorney unless the parties agree to something different. This agreement needs to be downloaded and then shared with the buyer and if the buyer has an attorney then also to that counselor as well. All parties involved will know exactly who has received contracts and the status of any necessary changes. They will also know who is responsible to make any changes and in a timely manor thereby avoiding any unnecessary delays. These are legal documents. If the user needs assistance or does not understand the contents, the user should seek legal counsel before signing and accepting them.

There are several unique features for Real Estate Selling Online. These include referrals, contact with every party involved in the sale or transaction, agreements, contracts, offers, negotiations, ordering, feedback from buyers, ratings of area professionals, information requests, ordering of sales materials, customizable links, advertising content swap, walk on showings, reports, scheduling and sales principals.

Additional features include the ebook The Real Estate Revolution, area discussion groups, Match Maker/Match Maker, fire sale, Paypal deposits, tracking of banks, tracking of contingencies, RESPA for accounting, due diligence status and multiple access levels for information

Forms and reports include inspections, commission agreements, property information, electronic tracking of showings by agents, advertising, without agent representation, proof of insurance, offers, Purchase and Sale, closing documents, Financial Institution full disclosure and appraisals. Downloadable printable forms include: offers, property information sheets, mapping, commission agreements, banking disclosure/status sharing, buyer interest notification and RESPA (settlement) forms.

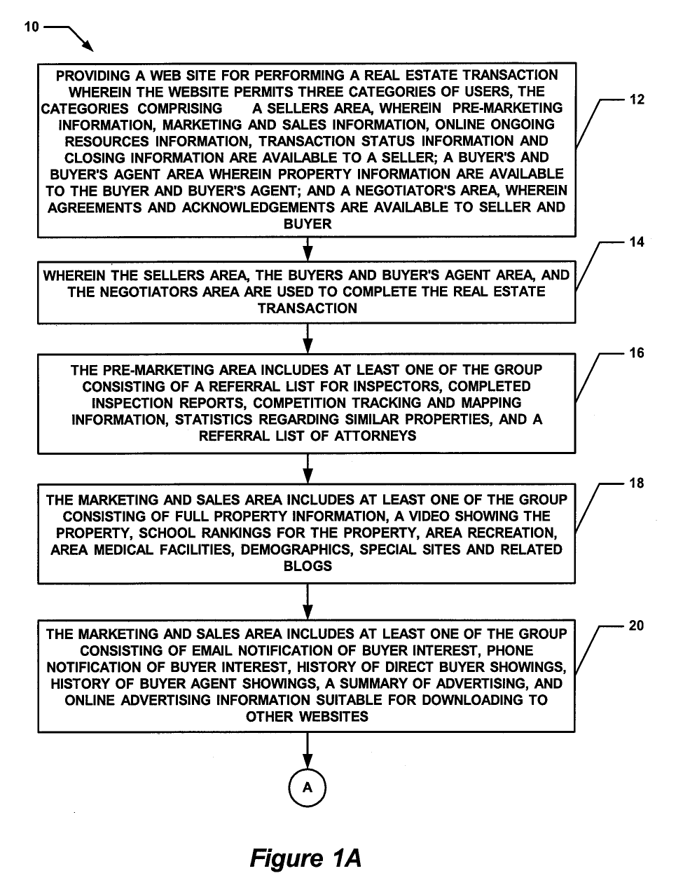

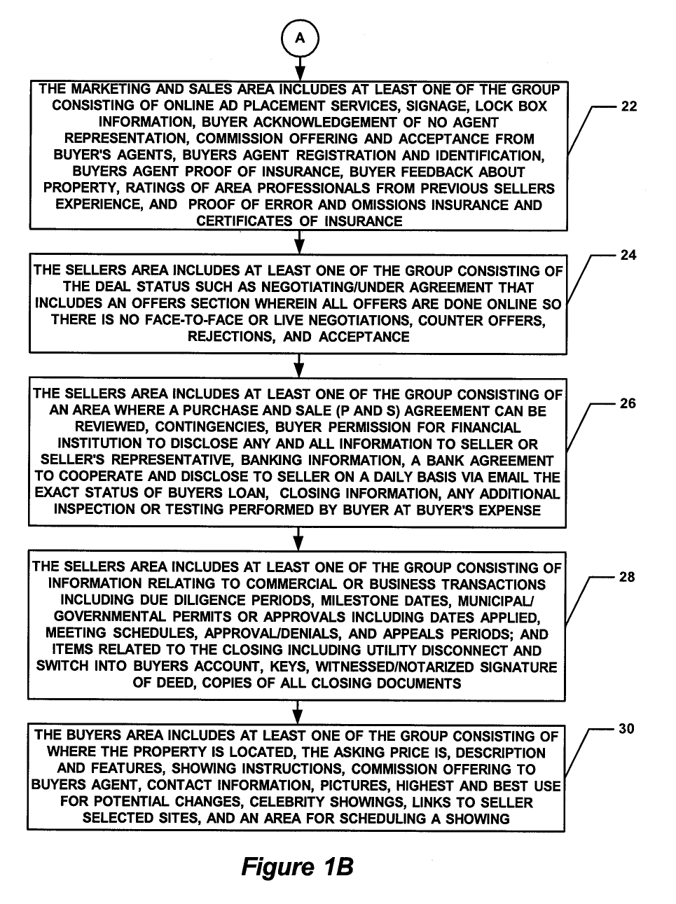

A flow chart of a particular embodiment of the presently disclosed method is depicted in FIGS. 1A and 1B. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIGS. 1A and 1B, method 10 starts with processing block 12 which discloses providing a web site for performing a real estate transaction wherein said website permits three categories of users, the categories comprising: a sellers area, wherein pre-marketing information, marketing and sales information, online ongoing resources information, transaction status information and closing information are Is available to a seller; a buyer's and buyer's agent area wherein property information are available to the buyer and buyer's agent; and a negotiator's area, wherein agreements and acknowledgements are available to seller and buyer. Each user has access to different areas of the website and can view different documents relating to the real estate transaction.

Processing block 14 states wherein the sellers area, the buyers and buyer's agent area, and the negotiators area are used to complete the real estate transaction. By way of the web site, an entire real estate transaction can be conducted.

Processing block 16 recites wherein the pre-marketing area includes at least one of the group consisting of a referral list for inspectors, completed inspection reports, competition tracking and mapping information, statistics regarding similar properties, and a referral list of attorneys.

Processing block 18 discloses wherein the marketing and sales area includes at least one of the group consisting of full property information, a video showing the property, school rankings for the property, area recreation, area medical facilities, demographics, special sites and related blogs.

Processing block 20 states wherein the marketing and sales area includes at least one of the group consisting of email notification of buyer interest, phone notification of buyer interest, history of direct buyer showings, history of Buyer Agent showings, a summary of advertising, and online advertising information suitable for downloading to other websites.

Processing continues with processing block 22 which recites wherein the marketing and sales area includes at least one of the group consisting of online ad placement services, signage, lock box information, buyer acknowledgement of no agent representation, commission offering and acceptance from buyer's agents, buyers agent registration and identification, buyers agent proof of insurance, buyer feedback about property, ratings of area professionals from previous sellers experience, and proof of error and omissions insurance and certificates of insurance.

Processing block 24 discloses wherein the sellers area includes at least one of the group consisting of the deal status such as negotiating/under agreement that includes an offers section (wherein all offers are done online so there is no face-to-face or live negotiations), counter offers, rejections, and acceptance.

Processing block 26 states wherein the sellers area includes at least one of the group consisting of an area where a Purchase and Sale (P and S) Agreement can be reviewed, contingencies, buyer permission for financial institution to disclose any and all information to seller or seller's representative, banking information, a bank agreement to cooperate and disclose to seller on a daily basis via email the exact status of buyers loan, closing information, and any additional inspection or testing performed by buyer at buyer's expense.

Processing block 28 discloses wherein the sellers area includes at least one of the group consisting of information relating to commercial or business transactions including due diligence periods, milestone dates, municipal/governmental permits or approvals including dates applied, meeting schedules, approval/denials, and appeals periods; and items related to the closing including utility disconnect and switch into buyers account, keys, witnessed/notarized signature of deed, copies of all closing documents.

Processing block 30 states wherein the buyers area includes at least one of the group consisting of where the property is located, the asking price, description and features, showing instructions, commission offering to buyers agent, contact information, pictures, highest and best use for potential changes, celebrity showings, links to seller selected sites, and an area for scheduling a showing.

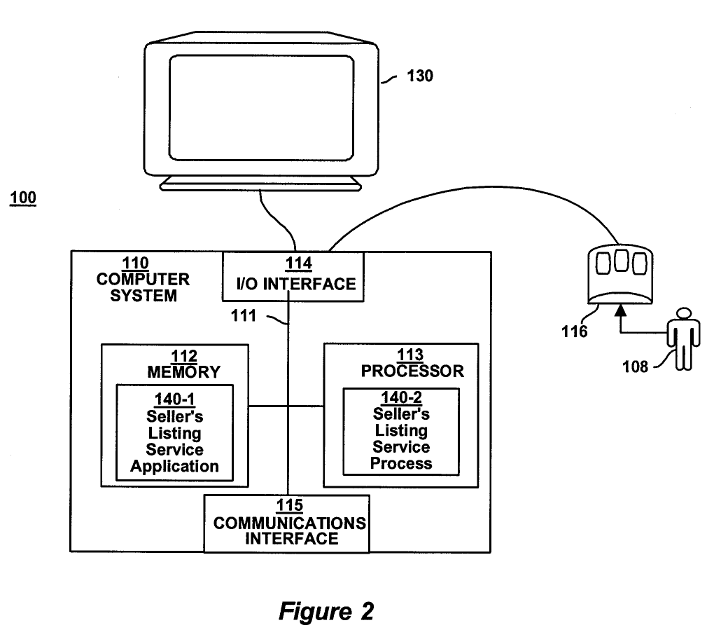

FIG. 2 is a block diagram illustrating an example computer system 100 for implementing seller's listing service function 140 and/or other related processes to carry out the different functionality as described herein.

As shown, computer system 100 of the present example includes an interconnect 111 that couples a memory system 112 and a processor 113 an input/output interface 114, and a communications interface 115.

As shown, memory system 112 is encoded with seller's listing service application 140-1. Seller's listing service application 140-1 can be embodied as software code such as data and/or logic instructions (e.g., code stored in the memory or on another computer readable medium such as a disk) that support functionality according to different embodiments described herein.

During operation, processor 113 of computer system 100 accesses memory system 112 via the interconnect 111 in order to launch, run, execute, interpret or otherwise perform the logic instructions of the seller's listing service application 140-1. Execution of seller's listing service application 140-1 produces processing functionality in seller's listing service process 140-2. In other words, the seller's listing service process 140-2 represents one or more portions of the seller's listing service application 140-1 (or the entire application) performing within or upon the processor 113 in the computer system 100.

It should be noted that, in addition to the seller's listing service process 140-2, embodiments herein include the seller's listing service application 140-1 itself (i.e., the un-executed or non-performing logic instructions and/or data). The seller's listing service application 140-1 can be stored on a computer readable medium such as a floppy disk, hard disk, or optical medium. The seller's listing service application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of seller's listing service application 140-1 in processor 113 as the seller's listing service process 140-2. Those skilled in the art will understand that the computer system 100 can include other processes and/or software and hardware components, such as an operating system that controls allocation and use of hardware resources associated with the computer system 100.

IS It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 112 (e.g., within random access memory or RAM). It is also to be understood that other embodiments of the invention can provide the applications operating within the processor 113 as the processes. While not shown in this example, those skilled in the art will understand that the computer system may include other processes and/or software and hardware components, such as an operating system, which have been left out of this illustration for ease of description of the invention.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a computer system performs operations of providing a seller's listing system for a real estate transaction, the method comprising:
providing a web site for performing a real estate transaction wherein said website permits three categories of users, the categories comprising:
a sellers area, wherein pre-marketing information, marketing and sales information, online ongoing resources information, transaction status information and closing information are available to a seller;
a buyer's and buyer's agent area wherein property information are available to the buyer and buyer's agent; and
a negotiator's area, wherein agreements and acknowledgements are available to seller and buyer; and
wherein said sellers area, said buyers and buyer's agent area, and said negotiators area are used to complete said real estate transaction.

2. The method of claim 1 wherein said pre-marketing area includes at least one of the group consisting of a referral list for inspectors, completed inspection reports, competition tracking and mapping information, statistics regarding similar properties, and a referral list of attorneys.

3. The method of claim 1 wherein said marketing and sales area includes at least one of the group consisting of full property information, a video showing said property, school rankings for said property, area recreation, area medical facilities, demographics, special sites and related blogs.

4. The method of claim 1 wherein said marketing and sales area includes at least one of the group consisting of email notification of buyer interest, phone notification of buyer interest, history of direct buyer showings, history of Buyer Agent showings, a summary of advertising, and online advertising information suitable for downloading to other websites.

5. The method of claim 1 wherein said marketing and sales area includes at least one of the group consisting of online ad placement services, signage, lock box information, buyer acknowledgement of no agent representation, commission offering and acceptance from Buyer's Agents, Buyers Agent registration and identification, Buyers Agent proof of insurance, Buyer feedback about property, ratings of area professionals from previous Sellers experience, and proof of error and omissions insurance and certificates of insurance.

6. The method of claim 1 wherein said sellers area includes at least one of the group consisting of the deal status such as Negotiating/under agreement that includes an Offers section wherein all offers are done online so there is no face-to-face or live negotiations, counter offers, rejections, and acceptance.

7. The method of claim 1 wherein said sellers area includes at least one of the group consisting of an area where a Purchase and Sale (P and S) Agreement can be reviewed, contingencies, buyer permission for financial institution to disclose any and all information to Seller or Seller's representative, banking information, a bank agreement to cooperate and disclose to Seller on a daily basis via email the exact status of buyers loan, closing information, any additional inspection or testing performed by buyer at buyer's expense.

8. The method of claim 1 wherein said sellers area includes at least one of the group consisting of information relating to commercial or business transactions including due diligence periods, milestone dates, municipal/governmental permits or approvals including dates applied, meeting schedules, approval/denials, and appeals periods; and items related to the closing including utility disconnect and switch into buyers account, keys, witnessed/notarized signature of deed, copies of all closing documents.

9. The method of claim 1 wherein said buyers area includes at least one of the group consisting of where the property is located, the asking price is, description and features, showing instructions, commission offering to buyers agent, contact information, pictures, highest and best use for potential changes, celebrity showings, links to seller selected sites, and an area for scheduling a showing.

10. A computer readable storage medium having computer readable code thereon for conducting a real estate transaction, the medium including instructions in which a computer system performs operations comprising:
providing a web site for performing a real estate transaction wherein said website permits three categories of users, the categories comprising:
a sellers area, wherein pre-marketing information, marketing and sales information, online ongoing resources information, transaction status information and closing information are available to a seller;
a buyer's and buyer's agent area wherein property information are available to the buyer and buyer's agent; and
a negotiator's area, wherein agreements and acknowledgements are available to seller and buyer; and
wherein said sellers area, said buyers and buyer's agent area, and said negotiators area are used to complete said real estate transaction.

11. The computer readable storage medium of claim 10 wherein said pre-marketing area includes at least one of the group consisting of a referral list for inspectors, completed inspection reports, competition tracking and mapping information, statistics regarding similar properties, and a referral list of attorneys.

12. The computer readable storage medium of claim 10 wherein said marketing and sales area includes at least one of the group consisting of full property information, a video showing said property, school rankings for said property, area recreation, area medical facilities, demographics, special sites and related blogs.

13. The computer readable storage medium of claim 10 wherein said marketing and sales area includes at least one of the group consisting of email notification of buyer interest, phone notification of buyer interest, history of direct buyer showings, history of Buyer Agent showings, a summary of advertising, and online advertising information suitable for downloading to other websites.

14. The computer readable storage medium of claim 10 wherein said marketing and sales area includes at least one of the group consisting of online ad placement services, signage, lock box information, buyer acknowledgement of no agent representation, commission offering and acceptance from Buyer's Agents, Buyers Agent registration and identification, Buyers Agent proof of insurance, Buyer feedback about property, ratings of area professionals from previous Sellers experience, and proof of error and omissions insurance and certificates of insurance.

15. The computer readable storage medium of claim 10 wherein said sellers area includes at least one of the group consisting of the deal status such as Negotiating/under agreement that includes an Offers section wherein all offers are done online so there is no face-to-face or live negotiations, counter offers, rejections, and acceptance.

16. The computer readable storage medium of claim 10 wherein said sellers area includes at least one of the group consisting of an area where a Purchase and Sale (P and S) Agreement can be reviewed, contingencies, buyer permission for financial institution to disclose any and all information to Seller or Seller's representative, banking information, a bank agreement to cooperate and disclose to Seller on a daily basis via email the exact status of buyers loan, closing information, any additional inspection or testing performed by buyer at buyer's expense.

17. The computer readable storage medium of claim 10 wherein said sellers area includes at least one of the group consisting of information relating to commercial or business transactions including due diligence periods, milestone dates, municipal/governmental permits or approvals including dates applied, meeting schedules, approval/denials, and appeals periods; and items related to the closing including utility disconnect and switch into buyers account, keys, witnessed/notarized signature of deed, copies of all closing documents.

18. The computer readable storage medium of claim 10 wherein said buyers area includes at least one of the group consisting of where the property is located, the asking price is, description and features, showing instructions, commission offering to buyers agent, contact information, pictures, highest and best use for potential changes, celebrity showings, links to seller selected sites, and an area for scheduling a showing.

19. A computer system comprising:
a memory;
a processor;
a communications interface;
an interconnection mechanism coupling the memory, the processor and the communications interface; and
wherein the memory is encoded with an application providing a sellers listing service, that when performed on the processor, provides a process for processing information, the process causing the computer system to perform the operations of:
providing a web site for performing a real estate transaction wherein said website permits three categories of users, the categories comprising:
a sellers area, wherein pre-marketing information, marketing and sales information, online ongoing resources information, transaction status information and closing information are available to a seller;
a buyer's and buyer's agent area wherein property information are available to the buyer and buyer's agent; and
a negotiator's area, wherein agreements and acknowledgements are available to seller and buyer; and
wherein said sellers area, said buyers and buyer's agent area, and said negotiators area are used to complete said real estate transaction.
